(19) United States
(12) Patent Application Publication
(10) Pub. No.: US 2025/0200648 A1
(43) Pub. Date: Jun. 19, 2025

(54) DATA AGGREGATION FOR THRESHOLDING-BASED ACCOUNT MANAGEMENT

(71) Applicant: Stripe, Inc., South San Francisco, CA (US)

(72) Inventors: Salil BAPAT, Bellevue, WA (US); Hanjun KIM, Seattle, WA (US); Andy ZHANG, Los Angeles, CA (US); Sumeet BEDI, Kirkland, WA (US); Devesh CHOURASIYA, Mountain View, CA (US); Jeremy CLEMENSON, Boulder, CO (US); Kasey KLIPSCH, Chicago, IL (US); Mark TOKUTOMI, Reno, NV (US); Sidharth VIJAYACHANDRAN, Issaquah, WA (US); Han Yi LEE, London (GB); Don MOYNIHAN, Dublin (IE)

(21) Appl. No.: 18/540,619

(22) Filed: Dec. 14, 2023

(51) Int. Cl. G06Q 40/02

(52) U.S. Cl. CPC G06Q 40/02

(57) ABSTRACT

Aspects of the subject technology allow an entity to aggregate transaction data for safeguarding. Aspects include obtaining a set of data items associated with a set of transactions, and, for each respective data item, determining a funding type corresponding to the respective data item based at least in part on a respective attribute and augmenting the respective data item based on the determined funding type and an attribute estimation. Aspects also include aggregating the set of data items into respective groups based on the funding type, the merchant identifier, and/or the jurisdiction identifier, and transmitting a respective group to a service for determining whether a respective bank account includes a threshold amount of funds based on the amounts of data items in the respective group.

### CROSS-REFERENCE TO RELATED APPLICATIONS

This application is related to U.S. patent application entitled “MACHINE-LEARNING BASED DELAY PREDICTION,” U.S. patent application entitled “DISTRIBUTED ASSETS MANAGEMENT PLATFORM,” U.S. patent application entitled “ASSETS INTERFACE OF A DISTRIBUTED ASSETS MANAGEMENT PLATFORM,” U.S. patent application entitled “HYDRATION SYSTEM IN A DISTRIBUTED ASSETS MANAGEMENT PLATFORM,” and U.S. patent application entitled “EXCHANGE PLATFORM IN A DISTRIBUTED ASSETS MANAGEMENT PLATFORM,” which were each filed on Dec. 14, 2023.

### TECHNICAL FIELD

The present description generally relates to electronic data management, including aggregating transaction data for managing accounts in view of safeguarding requirements.

### BACKGROUND

A financial service provider may be, for example, a payment service provider and/or an electronic money institution. A payment service provider may be a financial service provider that facilitates payments for businesses and/or consumers. Payment service providers may act as intermediaries in the payment process, connecting merchants, consumers, card networks, and/or other financial institutions. Payment service providers may provide the infrastructure for the secure processing of transactions, including the authorization, clearing, and/or settlement of payments. An electronic money institution may be a financial service provider authorized to issue electronic money (e-money), which may be a digital alternative to cash, stored on an electronic device or remotely at a server. Electronic money institutions may offer services similar to traditional banks but operate predominantly in the digital space. Electronic money institutions may provide payment services such as facilitating credit transfers, issuing payment instruments, and money remittances.

Financial service providers may manage balances of user funds in the form of fiat currency and/or e-money. Financial service providers may also process transactions (e.g., balance-impacting movements) involving such funds. Because of the amount of responsibility that financial service providers have in managing user funds, some countries have enacted safeguarding regulations aimed at protecting user funds in the event of the financial service provider's insolvency. The essence of safeguarding is to separate and protect user funds from the financial service provider's own funds, thereby preventing these user funds from being claimed by other creditors.

Financial service providers may operate under one or more entities, which may be legal entities corresponding to jurisdictions in which the financial service provider operates. For example, a financial service provider may be an American company and thus have an American entity but also have a UK entity and an EU entity for facilitating its operations in the UK and EU jurisdictions, respectively. However, safeguarding regulations and/or frameworks may vary on a per jurisdiction basis.

In the EU and the UK, for example, the safeguarding framework may direct funds received for the execution of payment transactions, whether from users or on behalf of users, to be kept separate from the financial service provider's own funds. This may be achieved by storing the funds in segregated bank accounts specifically designated for this purpose and tracking the status of user funds on a daily basis. This meticulous tracking may help funds to be returned to the rightful owners should the financial service provider face insolvency.

Beyond the EU and UK, other jurisdictions, such as Singapore, may have analogous safeguarding obligations. However, Singapore's regulations differ in that they do not enforce immediate segregation and allow for a more lenient timeframe for segregating funds. Additionally, Singapore's regulations permit the use of one merchant's funds to support another merchant's payouts under certain conditions. Accordingly, safeguarding regulations may vary from jurisdiction to jurisdiction, which may complicate safeguarding compliance for entities that handle multi- and/or cross-jurisdiction transactions.

### BRIEF DESCRIPTION OF THE DRAWINGS

Certain features of the subject technology are set forth in the appended claims. However, for the purpose of explanation, several embodiments of the subject technology are set forth in the following figures.

FIG. 1 illustrates an example network environment in which the subject technology may be implemented in accordance with one or more embodiments.

FIG. 2 depicts an example server that may implement the subject technology in accordance with one or more embodiments.

FIG. 3 depicts a diagram of an example aggregation processing pipeline in accordance with one or more embodiments.

FIG. 4 depicts a diagram of an example streaming processing pipeline in accordance with one or more embodiments.

FIG. 5 depicts a diagram of an example batch processing pipeline in accordance with one or more embodiments.

FIG. 6 depicts a flow diagram of an example process for processing transaction data to determine a safeguarding obligation in accordance with one or more embodiments.

FIG. 7 depicts an example electronic system with which aspects of the present disclosure may be implemented, in accordance with one or more embodiments.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other embodiments. In one or more embodiments, structures and components are shown in block diagram form in order to avoid obscuring the concepts of the subject technology.

As described above, safeguarding may involve separating user (e.g., merchant) funds from those of the financial service provider on a per jurisdiction basis, and/or may involve keeping accurate user-level records to facilitate the return of funds when necessary. Given the timing constraints of when funds are to be safeguarded (e.g., upon receipt), estimates (e.g., estimated settlement time) may be used, which could cause the safeguarded account to be over-/under-funded. While under-funding an account may result in a safeguarding violation, over-funding an account may result in inefficient allocation of an entity's funds.

The subject technology enables an entity to fund its safeguarded accounts, on a per jurisdiction basis, as close as possible to the actual safeguarding obligation for a given jurisdiction. In this manner, the subject technology allows a financial service provider to avoid the unnecessary immobilization of corporate funds (e.g., overestimating the safeguarding requirement ties up funds that could otherwise be used for business development or investment) while complying with the safeguarding regulations. Furthermore, the subject technology reduces the processing, memory, and/or communication resources associated with complying with safeguarding regulations by reducing or eliminating transactions (e.g., sweeps) needed to fund an under-funded account and/or transactions needed to withdraw from an over-funded account.

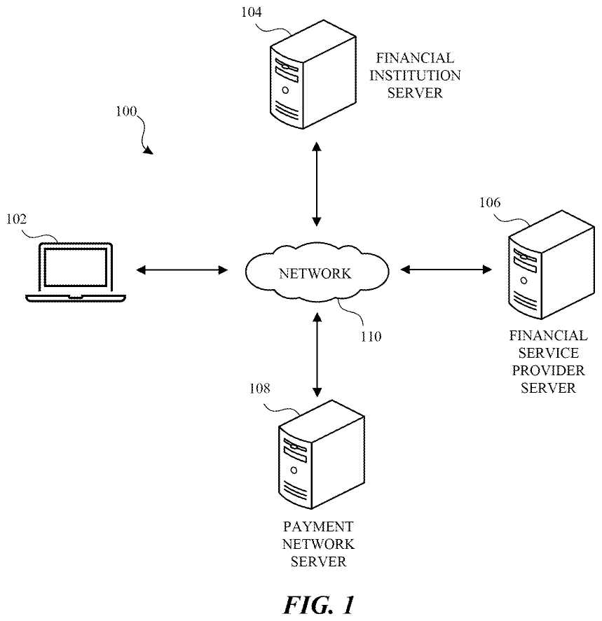

FIG. 1 illustrates an example network environment 100 in which the subject technology may be implemented in accordance with one or more embodiments. Not all of the depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

The network environment 100 may include an electronic device 102, a financial institution server 104, a financial service provider server 106, and a payment network server 108. The network 110 may communicatively (directly or indirectly) couple one or more of the electronic device 102, the financial institution server 104, the financial service provider server 106, and the payment network server 108. In one or more embodiments, the network 110 may be an interconnected network of devices that may include, or may be communicatively coupled to, the Internet.

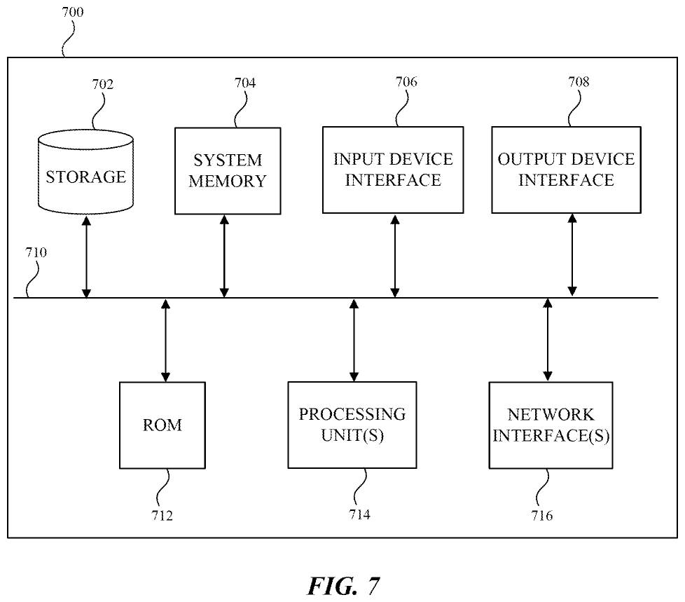

For explanatory purposes, the network environment 100 is illustrated in FIG. 1 as including the electronic device 102, the financial institution server 104, the financial service provider server 106, and the payment network server 108; however, the network environment 100 may include any number of electronic devices and/or any number of servers communicatively coupled to each other directly or via the network 110. In addition, the various systems of FIG. 1 may be, and/or may include all or part of, the electronic system discussed below with respect to FIG. 7.

The electronic device 102 may be, for example, a wearable device (such as a watch, a band, and the like), a desktop computer, a portable computing device (e.g., a laptop computer), a smartphone, a peripheral device (e.g., a digital camera, headphones), a tablet device, or any other appropriate device that includes, for example, one or more wireless interfaces, such as WLAN radios, cellular radios, Bluetooth radios, Zigbee radios, near field communication (NFC) radios, and/or other wireless radios. In FIG. 1, for example, the electronic device 102 is depicted as a laptop computer. The electronic device 102 may be associated with one or more accounts, credentials, or any other identity information registered with the financial service provider server 106 belonging to a user associated with the electronic device 102.

The financial service provider server 106 may include, for example, one or more servers that host or facilitate a service that may be used by one or more parties (e.g., the electronic device 102) and may act as a central hub for processing transactions (e.g., credit card payments, e-money payments, stored value payments, and the like). The financial service provider server 106 may store account information (e.g., user account, usernames/handles, or any other account-specific data) associated with the electronic device 102 and/or users thereof and/or users associated therewith. To process a charge, the financial service provider server 106 may communicate with the payment network server 108 to retrieve funds from a financial institution associated with the payment network server 108, which may include clearing and settlement of funds. To process a payout, the financial service provider server 106 may communicate with the financial institution server 104 to send funds from a user's available balance on the financial service provider server 106 to a financial institution (e.g., bank) associated with the user (e.g., the financial institution server 104 and/or another bank). The financial service provider server 106 may be, and/or may include all or part of, the electronic system discussed below with respect to FIG. 7.

The financial institution server 104 may include, for example, one or more servers that manage the daily operations of a corresponding financial institution (e.g., bank), including customer account management, transaction processing for deposits, withdrawals, and transfers, as well as interfacing with external networks for ATM and card payment services. The financial institution server 104 may maintain and update account balances, process payment instructions, manage customer data, and facilitate secure interactions with the online services of the financial institution. The financial institution server 104 may store account information (e.g., user account, usernames/handles, or any other account-specific data) associated with the electronic device 102 and/or users thereof and/or users associated therewith. The financial institution server 104 may be, and/or may include all or part of, the electronic system discussed below with respect to FIG. 7.

The payment network server 108 may include, for example, one or more servers that facilitate the communication and/or transaction processing between various financial institutions such as banks, financial service providers, and users (e.g., merchants). The payment network server 108 may be responsible for the secure and efficient transmission of transaction data across the payment network, which may include authorization requests from merchants, confirmation of funds from issuing banks, and the coordination of clearing and settlement processes. The payment network server 108 may store account information (e.g., user account, usernames/handles, or any other account-specific data) associated with the electronic device 102 and/or users thereof and/or users associated therewith. The payment network server 108 may be, and/or may include all or part of, the electronic system discussed below with respect to FIG. 7.

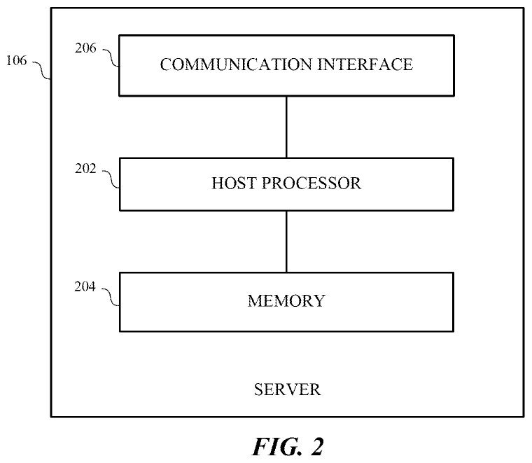

An example server device that may be implemented by one or more of the financial institution server 104, the financial service provider server 106 and/or the payment network server 108 is discussed further below with respect to FIG. 2.

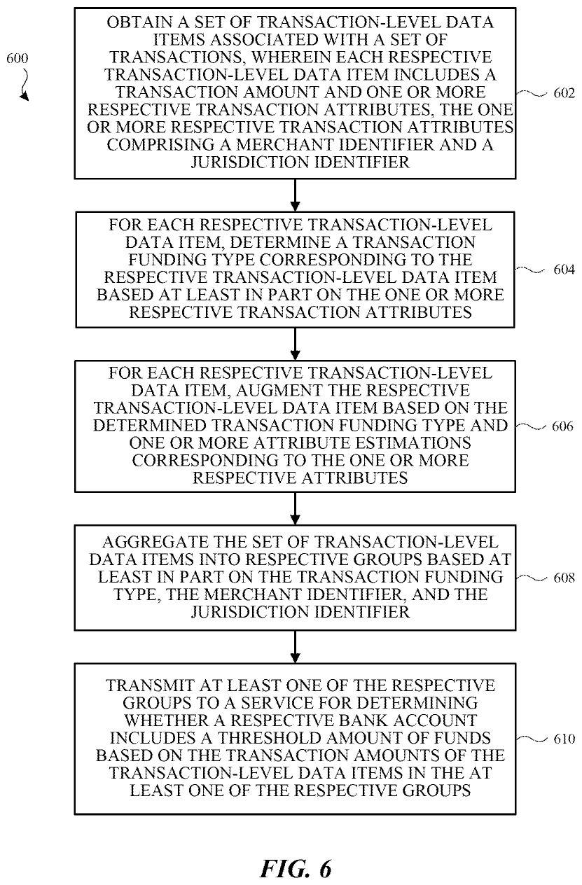

In operation, the financial service provider server 106 may receive transaction-level data corresponding to transactions that are associated with merchant accounts that are serviced by the financial service provider server 106, as well as transaction-level data corresponding to the internal accounts of the financial service provider server 106. The transaction-level data may be processed, filtered, augmented, and/or aggregated by the financial service provider server 106 for purposes of determining safeguarding obligations on a per jurisdiction basis in order to maintain the appropriate balances in such accounts to meet but ideally not exceed the safeguarding obligations. An example process of processing transaction-level data to determine a safeguarding obligation is discussed further below with respect to FIG. 6.

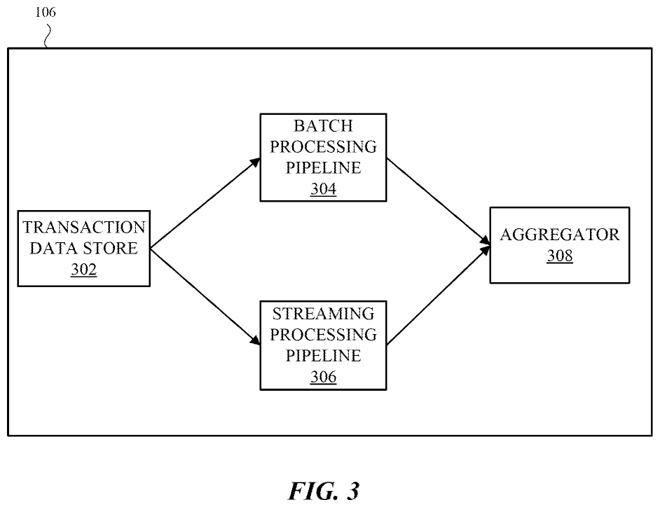

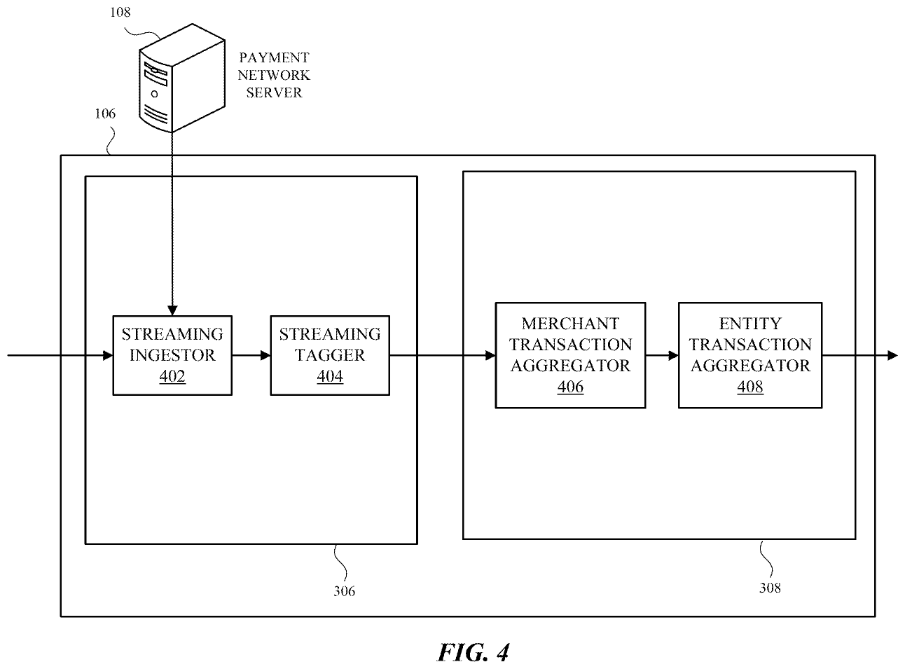

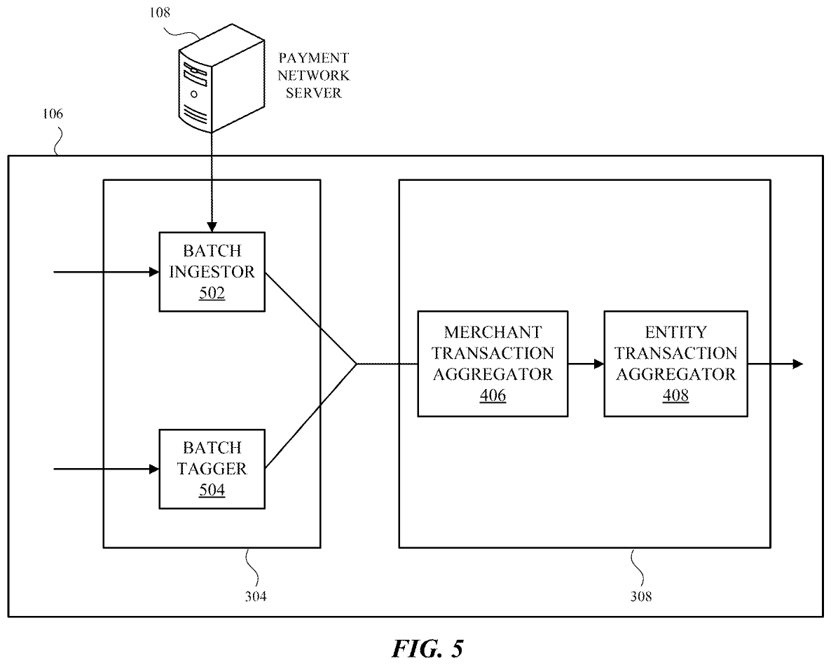

The financial service provider server 106 may implement one or more transaction processing pipelines for processing the transaction data, such as a batch processing pipeline (e.g., for periodic transaction data processing) and a streaming processing pipeline (e.g., for real-time transaction data processing), as is discussed below with respect to FIG. 3. The batch processing pipeline, which is primarily used for purposes of collecting and processing data in predefined intervals for scenarios where processing may be more complex and/or real-time data is not available, is discussed in more detail below with respect to FIG. 4 and the streaming processing pipeline, which is primarily used for purposes of collecting and processing data as it arrives for applications that utilize up-to-date information (e.g., safeguarding, fraud detection, and/or real-time dashboarding), is discussed in more detail below with respect to FIG. 5.

Upon utilizing the processing pipelines to determine the safeguarding obligation for a given account in a given jurisdiction, e.g., the amount of funds that should be present in the account at a particular time, the financial service provider server 106 may communicate the safeguarding obligation to an account management service which may move funds into or out of the account based on the safeguarding obligation and the account balance. In this manner, safeguarding obligations can be met by the financial service provider server 106 in a manner that minimizes the number of transactions into and/or out of a given account, thereby reducing the processing, memory, and/or communication resources associated with the safeguarding.

FIG. 2 depicts an example server that may implement the subject technology in accordance with one or more embodiments. For explanatory purposes, FIG. 2 is primarily described herein with reference to the financial service provider server 106 of FIG. 1. However, this is merely illustrative, and features of the server of FIG. 2 may be implemented in the financial institution server 104, the payment network server 108, and/or other device for implementing the subject technology. Not all of the depicted components may be used in all embodiments, however, and one or more embodiments may include additional or different components than those shown in FIG. 2. Variations in the arrangement and type of the components may be made without departing from the spirit or scope of the claims as set forth herein. Additional components, different components, or fewer components may be provided.

The financial service provider server 106 may include one or more of a host processor 202, a memory 204, and/or a communication interface 206. The host processor 202 may include suitable logic, circuitry, and/or code that enable processing data and/or controlling operations of the financial service provider server 106. In this regard, the host processor 202 may be enabled to provide control signals to various other components of the financial service provider server 106. The host processor 202 may also control transfers of data between various portions of the financial service provider server 106. The host processor 202 may further implement an operating system or may otherwise execute code to manage operations of the financial service provider server 106.

The memory 204 may include suitable logic, circuitry, and/or code that enable storage of various types of information such as received data, generated data, code, and/or configuration information. The memory 204 may include volatile memory (e.g., random access memory (RAM)) and/or non-volatile memory (e.g., read-only memory (ROM), flash, and/or magnetic storage).

The communication interface 206 may include suitable logic, circuitry, and/or code that enables wired or wireless communication, such as between the electronic device 102, the financial institution server 104, the financial service provider server 106, and/or the financial service provider server 106. The communication interface 206 may include, for example, one or more of a Bluetooth communication interface, an NFC interface, a Zigbee communication interface, a WLAN communication interface, a USB communication interface, a cellular interface, or generally any communication interface.

In one or more embodiments, one or more of the host processor 202, the memory 204, the communication interface 206, and/or one or more portions thereof may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

FIG. 3 depicts a diagram of an example aggregation processing pipeline implemented by a financial service provider server 106 in accordance with one or more embodiments. Not all depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

As discussed above, the financial service provider server 106 may receive transaction data each time a transaction (e.g., charge or payout event) occurs, and the financial service provider server 106 may store the transaction data in a transaction data store 302 of the financial service provider server 106. The financial service provider server 106 may implement one or more processing pipelines (e.g., a streaming processing pipeline 306 and/or a batch processing pipeline 304) that may receive, from the transaction data store 302, transactional-level data for each merchant. The transaction-level data may include, for example, a transaction amount and one or more attributes, such as transaction identifier, merchant identifier, currency identifier, and the like, as is discussed further below.

The transaction data store 302 may be a repository designed to store, manage, and/or facilitate the querying of transaction data. The transaction data store 302 may be implemented, for example, on a robust and scalable database management system (DBMS) that can handle high volumes of read and write operations, such as PostgreSQL, MySQL, or a NoSQL database like MongoDB, depending on the structure and use case of the data.

The transaction data store 302 may be designed with a schema optimized for transactions, typically involving tables or collections that store records of individual transactions, merchant information, user accounts, and/or the like. Each transaction record (also referred to herein as a “transaction-level data item”) may include a transaction amount and attributes such as transaction ID, merchant ID, user ID, currency, timestamp, payment method, status, and/or potentially a flag indicating whether the transaction has been reconciled. Inputs to the transaction data store 302 may come from various interfaces and/or services that capture transaction events (e.g., point-of-sale systems, e-commerce platforms, and mobile payment applications) through secure and encrypted channels (e.g., secure file transfer protocol (SFTP)). As for outputs, the transaction data store 302 may serve as the backbone for various financial and operational processes, such as the safeguarding system described herein and reporting systems (e.g., for financial reconciliation, compliance auditing, and analytics). The transaction data store 302 may also interface with other internal systems (e.g., fraud detection or customer service tools) enabling these systems to query transaction data to support business operations.

The transaction data store 302 may provide transaction-level data to the batch processing pipeline 304 and/or the streaming processing pipeline 306. In some embodiments, both pipelines may be in operation, where one is used as a source of truth while the other is adjusted to facilitate debugging, development, and/or the like. Regardless of the pipeline utilized, the transaction-level data may be processed by an ingestor (e.g., streaming ingestor 402) and a tagger (e.g., streaming tagger 404) before being passed to the aggregator 308, as is discussed further below with respect to FIG. 4.

The batch processing pipeline 304 may process the transaction-level data in batches and/or at a predetermined time of day (e.g., once per day at a cutoff time such as near the close of business for each jurisdiction). That is, data may be collected over a period and processed as a single group, which may be highly efficient for tasks that do not require real-time or near real-time analysis. Batch processing allows for the comprehensive analysis of large volumes of data, which may be beneficial for complex computations that are not time sensitive. Batch processing systems can handle very large data loads, as they are designed to process data in bulk. This can lead to more efficient use of computational resources during off-peak hours, potentially reducing operational costs. Moreover, since batch processing may deal with a complete set of data, batch processing may be more straightforward in terms of implementation and debugging, and batch processing can allow for more consistent and accurate results, especially for applications like financial reconciliation, where every transaction is to be accounted for without loss.

The streaming processing pipeline 306 may process the transaction-level data as it arrives or based on small buffers such that the transactions may be processed periodically throughout the day (e.g., hourly and/or near real time), thereby providing downstream services more accurate transaction information from which to make accounting decisions (e.g., sweeps, top-up, foreign exchange, etc.). This approach may benefit applications that require immediate data handling, such as fraud detection, settlement prediction, real-time analytics, and dynamic pricing models. In stream processing, data may be processed in small sizes, almost instantaneously after generation, which enables immediate insights and responses. Additionally, stream processing may allow for more dynamic systems that can adapt to changing data patterns in real-time, providing a more agile and responsive environment.

An ingestor (e.g., 402 in the streaming processing pipeline and 502 in the batch processing pipeline) (described in more detail with respect to FIGS. 4-5) may be at the head of a processing pipeline to join transaction-level data generated by the financial service provider server 106 with corresponding data generated by a remote server (e.g., payment network server 108). The ingestor may receive as input the transaction-level data from the transaction data store 302 (e.g., in batches or streams) as well as periodic reconciliation data (e.g., reports) from payment partners (e.g., Visa or Mastercard). The ingestor reconciles data received from the transaction data by modifying (e.g., correcting inaccurate information or inputting missing information) the transaction-level data based on the reconciliation data, which is acts a source of truth.

When reconciliation data has not been received for transaction-level data (e.g., due to delays from payment partners or processing lags), certain pieces of information might be missing or unconfirmed. Such information may include the final status of the transaction (e.g., confirmed, pending, or failed), precise settlement amounts, precise timestamp of settlement, and/or any fees or adjustments that might be applied by intermediaries or payment networks. For transaction-level data that cannot be completed or does not yet have a corresponding reconciliation data, estimates may be used to complete the transaction-level data so that the financial service provider may continue operations (e.g., financial reconciliations, risk assessments, and/or regulatory reporting) without having to wait for the reconciliation data. Estimates may be based on machine learning (ML) predictions and/or heuristics and serve as a stopgap, allowing the financial service provider to make informed estimations of the missing data based on historical trends, patterns, and/or known variables. For instance, ML models can predict the likely settlement amount based on similar past transactions or estimate the settlement time by analyzing the typical duration for transactions of a similar nature. With the estimated data, the safeguarding obligation can be estimated within the respective jurisdictional regulatory time constraint (e.g., the day the funds are received).

When reconciliation data arrives, the ingestor may identify and/or rectify discrepancies between the estimated and actual values. For instance, if the estimated settlement amount of a transaction differs from the actual amount reported by the reconciliation data, the ingestor may adjust the transaction record to reflect the correct amount. The output of the ingestor may be the completed transaction-level data (e.g., transaction-level data with estimations and/or reconciled transaction-level data).

A tagger (e.g., 404 and 504) (described in more detail with respect to FIGS. 4-5) may also be a part of a processing pipeline and may receive as input the transaction-level data (e.g., from the transaction data store 302 or the ingestor) and identifies transactions by funding type prior to the transaction-level data being aggregated. For example, the tagger may tag each transaction as being e-money (e.g., a digital alternative to cash, stored on an electronic device or remotely at a server) when the funding type of the transaction is e-money (e.g., as opposed to fiat currency), so that e-money transactions may be separately and/or differently safeguarded (e.g., swept and stored in a separate safeguarded account). For example, the tagger may augment the transaction-level data to include a field indicating whether the funding type of the transaction is e-money. Tagging transaction-level data as being e-money allows the financial service provider server 106 to also perform real-time safeguarding of e-money, which may be separately and/or differently safeguarded from other forms of money. The output of the tagging component may be the tagged completed transaction-level data.

The aggregator 308 may be designed to consolidate and/or summarize large volumes of data into a more manageable and practical format. A function of the aggregator 308 is to take detailed transaction-level data, which can be voluminous and complex, and transform it into aggregated data sets based on certain criteria such as merchant ID, transaction type (e.g., e-money or money), currency, jurisdiction, and/or other relevant dimensions. This process may involve grouping individual records that share common attributes and computing summary statistics like total amounts, averages, or counts. For example, the aggregator 308 may receive the tagged completed transaction-level data (e.g., output from the batch processing pipeline 304 and/or the streaming processing pipeline 306) and may aggregate the transactions by merchant ID, transaction type, and/or currency to determine a merchant cash balance (e.g., the balance to be held on behalf of merchants in a safeguarded account within a predetermined period of receipt of user funds). The output of the aggregator 308 may be a set of aggregated transactions that may be used by downstream services to determine merchant cash positions in any of the aggregated dimensions (e.g., merchant, legal entity, transaction funding type, currency), and thereby can be used to determine whether safeguarding obligations are being met on a per jurisdiction, merchant, and/or currency basis.

In some embodiments, the aggregator 308 may also group and/or partition the aggregated transactions by jurisdiction (e.g., a legal entity of the company associated with the financial service provider server 106) into shards. The shards may be distributed across multiple servers, which may be associated with the jurisdiction corresponding to the shard. For example, a shard (e.g., partition) of the transaction-level data corresponding to the UK may be sent to a server located in the UK for improved performance (e.g., reduced query latency) and increased scalability (e.g., a server may handle the subset of the transaction-level data relevant to its jurisdiction).

The use of the aggregator 308 may reduce the complexity and volume of data (e.g., completed transaction-level data), making the data more manageable and easier to process by downstream services. The simplification may help decision-makers and/or downstream services who rely on clear and concise data summaries to inform their strategies and/or operations. Using aggregator 308 may also enhance performance for downstream processes like reporting and analytics, as working with aggregated data may be computationally less intensive than processing thousands or millions of individual transaction records. The aggregator 308 may also play a role in data privacy and security, as it can anonymize sensitive details by presenting only aggregated information, thereby reducing the risk of exposing individual transaction details.

In terms of implementation, the aggregator 308 may be built on top of a scalable data processing platform, such as Apache Spark or Hadoop, which can handle large-scale data operations efficiently. The aggregator 308 may use complex SQL queries, map-reduce functions, and/or custom algorithms to perform its grouping and summarization tasks. In some embodiments, the grouping and summarization tasks might involve reading data from a distributed database or data store (e.g., output from batch processing pipeline 304 and/or streaming processing pipeline 306), processing the data in a distributed manner for improved scalability and efficiency, and then writing the aggregated results back to a database or a data store for further analysis and reporting.

The aggregator 308 can be batch-based and/or real-time, corresponding to the batch processing pipeline 304 and/or streaming processing pipeline 306. A batch-based aggregator may collect and process data in predefined intervals, suitable for scenarios where real-time data is not critical. In contrast, a real-time aggregator may process data as it arrives, which may be beneficial for applications that utilize up-to-date information, like safeguarding, fraud detection, and/or real-time dashboarding. In some embodiments, the aggregator 308 might also include features like filtering to exclude irrelevant data, error handling to deal with corrupt or missing data, and/or data validation to ensure the accuracy and consistency of the output.

As discussed above, the aggregator 308 may be used to determine a respective merchant cash balance for a given merchant serviced by the financial service provider server 106 in each respective jurisdiction in which the merchant performs transactions. A merchant cash balance may refer to the total amount of funds held by a financial service provider on behalf of a particular merchant in a particular jurisdiction (and/or in a particular currency) at a given time. The merchant cash balance may represent the cumulative total of transactions processed for the merchant, including sales, refunds, chargebacks, and/or any fees or adjustments. The aggregator 308 may collect and/or consolidate transaction-level data associated with each merchant and group the transaction-level data by various attributes such as merchant ID, transaction type, currency, jurisdiction, and/or date. The aggregator 308 may then compute the sum of one or more transactions (e.g., aggregated in one or more dimensions, such as merchant ID and transaction type) to determine the total cash balance for each merchant. This process may involve aggregating and/or tabulating all incoming funds (e.g., sales) and any outgoing funds (e.g., refunds or fees) associated with the merchant's account.

The merchant cash balances may be used in downstream processes to be compared with the safeguarded account balance. If too much merchant cash (e.g., an amount of merchant cash exceeding a predetermined threshold) is held in the safeguarded account, then funds may be automatically moved (e.g., via sweeping) from the safeguarded (e.g., merchant) account to non-safeguarded (e.g., financial service provider's interest-bearing) accounts, and vice versa, for proper safeguarding compliance. For example, all merchant funds may be initially received into the safeguarded account and the system performs a daily calculation to determine what portion of the merchant funds should remain in the safeguarded account. The system can then keep the determined portion in the safeguarded account and automatically sweep the rest of the received funds (e.g., representing the financial service provider's fees, commissions, or charges) into a non-safeguarded account (e.g., the financial service provider's interest-bearing account). In some examples, the threshold amount of funds is determined based on, for each merchant, a sum of inflows and outflows of merchant funds less any fees (e.g., gateway processor fee, scheme fee, interchange fee, acquiring fee, and/or the like).

FIG. 4 depicts a diagram of an example streaming processing pipeline 306 used by a financial service provider server 106 to process received transactions in accordance with one or more embodiments. Not all depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

As discussed above, a financial service provider server 106 may utilize a streaming processing pipeline 306 to process received transactions on a real-time or near real-time basis. The streaming processing pipeline 306 may be used to facilitate downstream services that rely on real-time or near real-time transaction information.

The streaming processing pipeline 306 may first pass received transaction data through a streaming ingestor 402. The streaming ingestor 402 may be a service designed to continuously receive, process, and/or manage transaction-level data in real-time or near real-time. A function is to ingest data streams including individual transaction records, each potentially containing various pieces of information such as transaction amounts, timestamps, merchant IDs, user data, and/or the like. The streaming ingestor 402 may operate on the principle of streaming data processing, where data is processed as it is received, rather than being stored and processed in batches. The technical implementation of a streaming ingestor 402 may involve a high-throughput, low-latency system capable of handling the large and continuous flow of transaction data such as Apache Kafka, Apache Flink, or other similar streaming platforms.

A functionality of a streaming ingestor 402 may include estimation and/or reconciliation of transaction-level data. Estimation by the streaming ingestor 402 may be performed when certain attributes of transaction-level data are incomplete or pending. Attributes (e.g., the final status of the transaction, precise settlement amounts, precise timestamp of settlement) may be missing due to the inherent delays in financial systems, such as awaiting settlement confirmations or processing delays from external payment networks (e.g., payment network server 108). To maintain operational continuity, the streaming ingestor 402 may use estimation techniques to predict the likely outcome or value of these incomplete transaction data. The estimations can be based on a variety of methods, ranging from heuristic rules to predictive models. Heuristic rules might involve using historical averages or common patterns observed in transaction data. In some examples, machine learning models can be employed, which are trained on historical transaction data items to predict outcomes based on observed patterns and correlations. The models may take into account various factors such as transaction size, merchant category, time of day, and/or historical trends to make accurate predictions.

The streaming ingestor 402 may also implement a reconciliation function with respect to the received transaction data. Reconciliation may include matching and/or verifying transaction-level data against reconciliation data to ensure accuracy of the transaction-level data. Reconciliation may involve comparing transaction-level data with reconciliation data (e.g., statements, confirmations, and/or other reports received) from payment networks, banks, and/or other financial institutions (e.g., payment network server 108) to identify and/or correct any discrepancies. For instance, reconciliation data may include the actual amount that settled for a transaction, which may be compared to the estimated settlement amount of the transaction.

The streaming ingestor 402 may continuously receive reconciliation data from external sources and match each reconciliation item with its corresponding entry in its internal records (e.g., the transaction-level data). The reconciliation process may be used to validate the completeness and accuracy of each transaction recorded by the financial service provider. The reconciliation process may rely on unique identifiers and transaction details to match records accurately, which may include transaction IDs, timestamps, amounts, merchant IDs, and/or user account information. The streaming ingestor 402 may cross-reference these attributes of transaction-level with the reconciliation data.

When a match is found between the transaction-level data items and the reconciliation data, and a matched transaction-level data item includes one or more estimated attributes, the estimated attributes of the transaction-level data item may be replaced (e.g., updated or modified) with the actual data from the corresponding reconciliation data. Similarly, if the transaction-level data item includes any missing attributes (e.g., an attribute that could not be estimated due to insufficient historical data), the missing attributes of the transaction-level data item may be filled in with the actual data from the corresponding reconciliation data. After the attributes of the transaction-level data item are updated based on the reconciliation data, an attribute of the transaction-level data item may be updated to indicate that it has been reconciled, confirming and/or finalizing its accuracy.

The output of the streaming ingestor 402 may be provided as input to the streaming tagger 404. The streaming tagger 404 may be designed to categorize and/or label (e.g., tag) transaction data based on predefined criteria and output the transaction-level data with additional metadata indicating, for example, whether a corresponding transaction involves e-money.

The streaming tagger 404 may operate by analyzing the attributes of each transaction of the transaction-level data, such as the source and destination of funds, transaction amount, type of transaction (e.g., deposit, withdrawal, or transfer), and/or the funding type and/or source of the accounts involved (e.g., bank account or digital wallet). Based on the analysis, the streaming tagger 404 may apply a set of rules or algorithms to determine if the corresponding transaction qualifies as e-money. The rules may be defined in accordance with regulatory standards and/or organizational policies regarding e-money transactions, such as on a per jurisdictional basis. For instance, a transaction may be tagged as e-money if the transaction involves funds credited to a prepaid account or a digital wallet, as opposed to a direct bank transfer or credit card payment. To determine whether the corresponding transaction qualifies as e-money, the streaming tagger 404 might use deterministic logic (e.g., hard-coded rules) and/or machine learning models (e.g., trained based on historical transaction-level data for historical transactions tagged as being e-money).

The output of the streaming tagger 404, and thus the output of the streaming processing pipeline 306, may be provided as input to the aggregator 308. As described above, the aggregator 308 may receive the completed and tagged transaction-level data and perform subsequent aggregation and/or sharding operations.

In some embodiments, as shown in FIG. 4, the merchant transaction aggregator 406 may group the completed and tagged transaction-level data based on merchant IDs, such as for a given jurisdiction (and/or in a given currency). This may involve collating all transactions associated with each individual merchant in the given jurisdiction, effectively creating a comprehensive view of each merchant's transactional activity (e.g., sales, refunds, charges, etc.) and making it easier to analyze and manage financial data for each merchant. The merchant-level aggregation not only provides a clear financial picture for each merchant but also simplifies tasks like calculating total sales, refunds, or fees, and aids in generating individualized financial statements or reports. For example, to determine the merchant cash balance, amounts of each transaction-level data item may be re-played chronologically up to the present and added together for a particular merchant. Additionally, because the aggregation is performed at the transaction level, when a transaction-level data item changes (e.g., reconciliation data replaces estimated attributes of one or more transaction-level data items), the amounts of each transaction-level data item may be re-played and re-added together for a particular merchant.

In some embodiments, once the transactions are aggregated by merchant, the entity transaction aggregator 408 may group the data by entity, which may be a legal or operational divisions within the financial service provider's business structure, such as different regional operations, currency-based divisions, or distinct legal entities within the larger corporate structure. Grouping may include sharding the data by entity. Sharding may refer to a database architecture technique used to distribute a large dataset across multiple databases, tables, or other forms of data stores to improve, for example, manageability and performance. By sharding the aggregated data, the financial service provider server 106 can efficiently manage and store large volumes of transaction information (e.g., across a plurality of servers, each corresponding to a jurisdiction associated with a particular shard). Sharding not only helps enhance the performance of the data store by reducing the load on any single server but may also improve data retrieval time and query performance. For example, the transaction data specific to the European Union jurisdiction may be sharded and stored on a European-based server, which may be used to determine the safeguarding obligations of the European entity of the company.

FIG. 5 depicts a diagram of an example batch processing pipeline 304 in accordance with one or more embodiments. Not all depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

As discussed above, a financial service provider server 106 may utilize a batch processing pipeline 304 to process received transactions on a periodic basis. The batch processing pipeline 304 may be used to facilitate downstream services that rely on larger volumes of data but do not require real-time or near real-time transaction information.

The batch processing pipeline 304 may include a batch ingestor 502 and a batch tagger 504. In the batch processing pipeline 304, the batch ingestor 502 and batch tagger 504 may work in tandem to process large volumes of transaction data in discrete intervals. Unlike their streaming counterparts, the batch ingestor 502 and batch tagger 504 may be designed to handle data in batches, dealing with accumulated transactions over a specific period, such as daily, and therefore the batch ingestor 502 and the batch tagger 504 may operate on the batches of data in parallel.

A role of the batch ingestor 502 may be the similar to the streaming ingestor 402 but may include intaking and processing transaction-level data that has been collected over a predetermined time frame. This process may begin with the batch ingestor 502 pulling transaction data from one or more sources, such as the transaction data store 302, a payment gateway, a bank interface, and/or other internal data stores. The transaction-level data ingested may encompass various details like transaction amounts, dates, merchant IDs, user information, and other relevant transaction information. Also like the streaming ingestor 402, a functionality of the batch ingestor 502 may include estimation and/or reconciliation of transaction-level data. In some embodiments, the batch ingestor 502 may receive the transaction-level data until a cutoff time (e.g., near the close of business in a particular jurisdiction) and then perform estimation and/or perform reconciliation on the received transaction-level data and output the resulting transaction-level data. In some embodiments, the batch ingestor 502 may receive the transaction-level data, perform estimation, and/or perform reconciliation and buffer the resulting transaction-level data until a cutoff time after which the batch ingestor 502 outputs the buffer.

While the batch ingestor 502 is processing the transaction-level data, the batch tagger 504 may categorize and/or label the transaction-level data based on predetermined criteria. Similar to its streaming counterpart, the batch tagger 504 may apply tags and/or labels to each transaction, identifying characteristics such as the type of transaction (e.g., e-money or money), the nature of the accounts involved, or other categories relevant to the business or regulatory requirements. The tagging may be rule-based, relying on a predefined set of criteria and logic to classify each transaction, and/or machine-learning-based, relying on historical transaction-level data and corresponding historical tags and/or labels. The transaction-level data may include an identifier (e.g., a record identifier) so that the output of the batch ingestor 502 may be matched with the output of the batch tagger 504. In some examples, the merchant transaction aggregator 406 may correlate (e.g., match or combine) the output of the batch ingestor 502 and the output of the batch tagger 504 to form a unified set of transaction-level data including estimations from the batch ingestor 502 and tags from the batch tagger 504.

Running the batch ingestor 502 and batch tagger 504 in tandem as part of a batch processing pipeline may offer a number of advantages. Firstly, running the batch ingestor 502 and batch tagger 504 in tandem may be efficient for processing large volumes of data, as the system can leverage the full computational resources during the batch processing window, which may be scheduled during off-peak hours to optimize system performance and minimize operational disruptions. Secondly, batch processing may provide a more controlled environment for data processing, which can be advantageous for complex calculations, extensive data validation, and/or compliance checks that might be too resource-intensive for real-time processing. For example, the batch ingestor 502 and the batch tagger 504 may be used to determine the safeguarding obligations for multiple jurisdictions with high transaction volume.

FIG. 6 depicts a flow diagram of an example process 600 for processing transaction data to determine a safeguarding obligation in accordance with one or more embodiments. For explanatory purposes, the process 600 is primarily described herein with reference to the electronic device 102, the financial institution server 104, the financial service provider server 106, and the payment network server 108 of FIG. 1. However, the process 600 is not limited to the electronic device 102, the financial institution server 104, the financial service provider server 106, and the payment network server 108, and one or more blocks of the process 600 may be performed by one or more other by other suitable devices. Further, for explanatory purposes, the blocks of the process 600 are described herein as occurring sequentially or linearly. However, multiple blocks of the process 600 may occur in parallel. In addition, the blocks of the process 600 need not be performed in the order shown and/or one or more blocks of the process 600 need not be performed and/or can be replaced by other operations.

The process 600 may be used by a financial service provider server 106 to process transaction data and determine a safeguarding obligation, as described above with respect to FIG. 3. The process 600 may be used by the financial service provider server 106 periodically with batches of transactions, as described above with respect to FIG. 4, and/or the process 600 may be used by the financial service provider server 106 continuously with streams of transactions, as described above with respect to FIG. 5.

At block 602, a server (e.g., the financial service provider server 106) may receive, access, download, or otherwise obtain a set of transaction-level data items associated with a set of transactions. The set of transaction-level data items may include one or more records from a data store (e.g., transaction data store 302) representing the set of transactions. The set of transaction-level data items may be obtained in batches (e.g., batch processing pipeline 304), in which case the remaining steps of the process 600 may be performed periodically (e.g., daily) on the batch. The transaction-level data items may also or instead be obtained as a stream (e.g., one data item at a time or one transaction at a time, in a streaming processing pipeline 306), in which case the process 600 may be performed as each is obtained.

Each transaction-level data item may include a transaction amount and one or more attributes, such as a merchant identifier representing the merchant engaged in the corresponding transaction, a currency identifier representing the currency in which the corresponding transaction is conducted, a jurisdiction identifier representing the legal entity associated with the corresponding transaction, a settlement date represent when the funds of the transaction have been transferred (e.g., by a card network) and/or reconciled, and/or a transaction funding type representing whether the corresponding transaction is conducted in e-money. In some embodiments, each jurisdiction may correspond to a separate bank account.

For each transaction-level data item, block 604 and block 606 may be performed. In some embodiments, blocks 604 and 606 may be performed on a batch of transaction-level data items at a predetermined time of day.

At block 604, the server may determine a transaction funding type corresponding to the transaction-level data item. Determining the transaction funding type corresponding to the transaction-level data item may include determining whether the corresponding transaction is an e-money transaction. Determining (e.g., by a streaming tagger 404) whether a transaction is e-money may be based on the attributes of the transaction included in the transaction-level data item(s). The attributes can include the nature of the fund's source, the type of account involved, the transaction's purpose, and/or the parties involved in the transaction. For instance, if a transaction involves loading funds onto a prepaid card or digital wallet, it would likely be tagged as e-money.

The determination may be based on rule-based logic (e.g., heuristics) and/or machine learning algorithms. Rule-based logic may include a set of predefined rules that reflect the financial service provider's policies and/or regulatory requirements as to what is considered e-money. For example, a rule might specify that any transaction crediting funds to a virtual account should be tagged as e-money.

In more complex scenarios, such as where transactions do not clearly fall into predefined categories, machine learning algorithms may be employed. Machine learning algorithms may analyze historical transaction data to identify patterns and characteristics common to transactions labeled as being e-money transactions. By learning from this data, the machine learning algorithm can predict whether a new transaction is e-money, even if it does not explicitly match the predefined rules.

At block 606, the server may modify, update, change, adjust, tag, or otherwise augment the transaction-level data item with the transaction funding type and/or one or more estimations. If it is determined that the transaction-level data item corresponds to an e-money transaction, an attribute (e.g., a transaction funding type attribute) of the transaction-level data item may be updated (e.g., by a streaming tagger 404) as an e-money transaction. In some embodiments, if it is determined that the transaction-level data item corresponds to an e-money transaction, an attribute of the transaction-level data item may be tagged (e.g., appended or added) to the transaction-level data item indicating that it corresponds to an e-money transaction.

Furthermore, due to the variable nature of settlement data (e.g., reconciliation data) from payment networks (e.g., from payment network servers 108), the transaction-level data item may be incomplete and/or inaccurate by the time the server determines the safeguarding obligation (e.g., after a predetermined cutoff time for the day). For example, the clearance request for the transaction may indicate a particular amount for the transaction but a different amount may actually settle leading to the transaction-level data item being inaccurate. As another example, if the transaction has not settled, the settlement time may be unavailable and thus the settlement time attribute of the corresponding transaction-level data item may be incomplete. To allow for a more accurate determination of safeguarding obligations, the server may generate (e.g., by the streaming ingestor 402) one or more estimations to complete and/or correct one or more attributes of the transaction-level data.

Machine learning approaches to estimation may involve training models on historical transaction data items to identify patterns and make predictions about incomplete transactions. For instance, a machine learning model might learn to predict the typical time it takes for a transaction to move from initiation to settlement and use this to estimate the current value of in-process transactions for safeguarding purposes. Machine learning techniques like neural networks, classifiers, decision trees, and/or ensemble methods can be used.

Additionally or alternatively, statistical approaches to estimation may be used to make predictions about incomplete transactions. Statistical approaches may involve techniques like regression analysis, time-series forecasting, and/or probabilistic models. For example, time-series models may be used to predict future transaction volumes based on historical trends, which can be useful for estimating safeguarding obligations over regular intervals.

At block 608, the server may aggregate (e.g., by the aggregator 308) the set of transaction-level data items into respective groups based at least in part on one or more attributes of the transaction-level data items. For example, each group may represent one or more merchant identifiers, a transaction funding type (e.g., e-money), a jurisdiction identifier, and/or a currency identifier. In one or more implementations, the one or more merchant identifiers may be used for purposes of separating the merchants' transactions from transactions corresponding to internal accounts of the financial service provider server 106. Thus, a group of transaction-level data items may correspond to, for example, all merchant transactions of a particular transaction funding type (e.g., e-money) in a particular jurisdiction/country that settles to a particular currency (e.g., dollars, Euros, etc.).

In one or more implementations, each of the one or more groups may be further aggregated into one or more shards. Sharding may refer to an approach for database management and optimization in which a data store (e.g., a table) is divided into subsets (e.g., smaller tables). Sharding may be based on, e.g., the size of the data, access patterns, and/or organizational structure. For example, aggregated groups can be sharded based on geographical regions, different currencies, or types of transactions. Sharding by geographical region would mean creating separate data stores for each region, such as North America, Europe, or Asia. Sharding based on geographical region may be beneficial if the transaction volume is particularly high in specific regions, or if there are distinct regulatory requirements in different geographies. Similarly, sharding by currency can optimize the processing and analysis of transactions for entities operating in multiple currency environments, reducing currency conversion complexities and related risks.

At block 610, the server may transmit (e.g., send, deliver, upload) at least one of the groups to a service (e.g., a process and/or device) for determining whether a bank account includes a threshold amount of funds. The bank account may correspond to a jurisdiction identifier of the group and the threshold may be a safeguarding obligation calculated based on the transaction amounts of transaction-level data items in the group. In some examples, the sum of the transaction amounts of the transaction-level data items in the group may be transmitted to the service in addition to or instead of the group.

If the amount of funds in the bank account is above the safeguarding obligation attributable to the bank account, excess funds may be transferred (e.g., swept) to a non-safeguarded account to minimize idle funds (e.g., to provide funding to under-funded accounts, to generate interest, etc.). If the amount of funds in the bank account is below the safeguarding obligation attributable to the bank account, additional funds may be requested for transfer into the bank account. For example, funds may be transferred from another bank account or borrowed from another entity. In some embodiments, transmitting the one or more groups may occur at a predetermined time of day (e.g., the end of the day).

After augmenting the transaction-level data items with one or more estimations, reconciliation data may be downloaded, received, accessed, or otherwise obtained (e.g., from payment network server 108). The attributes of the transaction-level data items that were augmented with estimations may be augmented with the corresponding data from the reconciliation data so that the transaction-level data items accurately reflect their corresponding transactions.

FIG. 7 depicts an example electronic system 700 with which aspects of the present disclosure may be implemented, in accordance with one or more embodiments. The electronic system 700 can be, and/or can be a part of, any electronic device for generating the features and processes described in reference to FIGS. 1-6, including but not limited to a laptop computer, tablet computer, smartphone, and wearable device (e.g., smartwatch, fitness band). The electronic system 700 may include various types of computer-readable media and interfaces for various other types of computer-readable media. The electronic system 700 includes one or more processing unit(s) 714, a persistent storage device 702, a system memory 704 (and/or buffer), an input device interface 706, an output device interface 708, a bus 710, a ROM 712, one or more processing unit(s) 714, one or more network interface(s) 716, and/or subsets and variations thereof.

The bus 710 collectively represents all system, peripheral, and chipset buses that communicatively connect the numerous internal devices of the electronic system 700. In one or more embodiments, the bus 710 communicatively connects the one or more processing unit(s) 714 with the ROM 712, the system memory 704, and the persistent storage device 702. From these various memory units, the one or more processing unit(s) 714 retrieves instructions to execute and data to process in order to execute the processes of the subject disclosure. The one or more processing unit(s) 714 can be a single processor or a multi-core processor in different embodiments.

The ROM 712 stores static data and instructions that are needed by the one or more processing unit(s) 714 and other modules of the electronic system 700. The persistent storage device 702, on the other hand, may be a read-and-write memory device. The persistent storage device 702 may be a non-volatile memory unit that stores instructions and data even when the electronic system 700 is off. In one or more embodiments, a mass-storage device (such as a magnetic or optical disk and its corresponding disk drive) may be used as the persistent storage device 702.

In one or more embodiments, a removable storage device (such as a floppy disk, flash drive, and its corresponding disk drive) may be used as the persistent storage device 702. Like the persistent storage device 702, the system memory 704 may be a read-and-write memory device. However, unlike the persistent storage device 702, the system memory 704 may be a volatile read-and-write memory, such as RAM. The system memory 704 may store any of the instructions and data that one or more processing unit(s) 714 may need at runtime. In one or more embodiments, the processes of the subject disclosure are stored in the system memory 704, the persistent storage device 702, and/or the ROM 712. From these various memory units, the one or more processing unit(s) 714 retrieves instructions to execute and data to process in order to execute the processes of one or more embodiments.

The bus 710 also connects to the input device interfaces 706 and output device interfaces 708. The input device interface 706 enables a user to communicate information and select commands to the electronic system 700. Input devices that may be used with the input device interface 706 may include, for example, alphanumeric keyboards, touch screens, and pointing devices. The output device interface 708 may enable the electronic system 700 to communicate information to users. For example, the output device interface 708 may provide the display of images generated by electronic system 700. Output devices that may be used with the output device interface 708 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more embodiments may include devices that function as both input and output devices, such as a touchscreen. In these embodiments, feedback provided to the user can be any form of sensory feedback, such as visual feedback, auditory feedback, or tactile feedback; and input from the user can be received in any form, including acoustic, speech, or tactile input.

The bus 710 also couples the electronic system 700 to one or more networks and/or to one or more network nodes through the one or more network interface(s) 716. In this manner, the electronic system 700 can be a part of a network of computers (such as a local area network, a wide area network, an Intranet, or a network of networks, such as the Internet). Any or all components of the electronic system 700 can be used in conjunction with the subject disclosure.

Embodiments within the scope of the present disclosure can be partially or entirely realized using a tangible computer-readable storage medium (or multiple tangible computer-readable storage media of one or more types) encoding one or more computer-readable instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more embodiments, the tangible computer-readable storage medium can be directly coupled to a computing device, while in other embodiments, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more embodiments are performed by one or more integrated circuits, such as ASICs or FPGAs. In one or more embodiments, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be re-arranged, or that all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together into a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more embodiments, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, an embodiment, the embodiment, another embodiment, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
obtaining a set of data items associated with a set of transactions, wherein each respective data item includes an amount and one or more respective attributes, the one or more respective attributes comprising a merchant identifier and a jurisdiction identifier;
for each respective data item:
determining a funding type corresponding to the respective data item based at least in part on the one or more respective attributes; and
augmenting the respective data item based on the determined funding type and one or more attribute estimations corresponding to the one or more respective attributes;
aggregating the set of data items into respective groups based at least in part on the funding type, the merchant identifier, and the jurisdiction identifier; and
transmitting at least one of the respective groups to a service for determining whether a respective bank account includes a threshold amount of funds based on the amounts of data items in the at least one of the respective groups.

2. The method of claim 1, wherein augmenting the respective data item with the one or more attribute estimations comprises:
identifying one or more incomplete attributes of the one or more respective attributes of the respective data item;
obtaining the one or more attribute estimations for the one or more incomplete attributes; and
adjusting the one or more incomplete attributes based at least in part on the one or more attribute estimations.

3. The method of claim 1, wherein the one or more attribute estimations are obtained from a machine learning model, wherein the machine learning model is trained based on historical data items.

4. The method of claim 1, wherein the one or more respective attributes of a respective data item include a settlement date and the one or more attribute estimations include an estimated settlement date.

5. The method of claim 1, wherein the set of data items are obtained as a batch and the method is performed on a periodic basis.

6. The method of claim 1, wherein the set of data items are obtained as a stream and the method is performed as each data item is obtained.

7. The method of claim 1, wherein transmitting the at least one of the respective groups occurs at a predetermined time of day.

8. The method of claim 1, further comprising:
obtaining reconciliation data associated with a data item of the set of data items; and
updating the one or more attribute estimations of the data item based at least in part on the reconciliation data.

9. The method of claim 1, wherein the funding type indicates that the respective data item is associated with e-money funds.

10. The method of claim 1, wherein the one or more respective attributes further comprises a currency identifier, and the set of data items are aggregated into respective groups further based on the currency identifier.

11. The method of claim 1, wherein transmitting the at least one of the respective groups comprises transmitting a sum of the amounts of the data items in the at least one of the respective groups.

12. An electronic device comprising:
a memory; and
a processor configured to:
obtain a set of data items associated with a set of transactions, wherein each respective data item includes an amount and one or more respective attributes, the one or more respective attributes comprising a merchant identifier and a jurisdiction identifier;
for each respective data item:
determine a funding type corresponding to the respective data item based at least in part on the one or more respective attributes; and
augment the respective data item based on the determined funding type and one or more attribute estimations corresponding to the one or more respective attributes;
aggregate the set of data items into respective groups based at least in part on the funding type, the merchant identifier, and the jurisdiction identifier; and
transmit at least one of the respective groups to a service for determining whether a respective bank account includes a threshold amount of funds based on the amounts of data items in the at least one of the respective groups.

13. The electronic device of claim 12, wherein the processor is configured to augment the respective data item with the one or more attribute estimations by:
identifying one or more incomplete attributes of the one or more respective attributes of the respective data item;
obtaining the one or more attribute estimations for the one or more incomplete attributes; and
adjusting the one or more incomplete attributes based at least in part on the one or more attribute estimations.

14. The electronic device of claim 12, wherein the one or more attribute estimations are obtained from a machine learning model, wherein the machine learning model is trained based on historical data items.

15. The electronic device of claim 12, wherein the one or more respective attributes of a respective data item include a settlement date and the one or more attribute estimations include an estimated settlement date.

16. The electronic device of claim 12, wherein the set of data items are obtained as a batch and the obtaining, determining, augmenting, aggregating, and transmitting steps are performed on a periodic basis.

17. The electronic device of claim 12, wherein the set of data items are obtained as a stream and the obtaining, determining, augmenting, aggregating, and transmitting steps are performed as each data item is obtained.

18. The electronic device of claim 12, wherein transmitting the at least one of the respective groups occurs at a predetermined time of day.

19. The electronic device of claim 12, wherein the processor is further configured to:
obtain reconciliation data associated with a data item of the set of data items; and
update the one or more attribute estimations of the data item based at least in part on the reconciliation data.

20. A non-transitory computer-readable medium comprising:
computer-readable instructions that, when executed by a processor, cause the processor to perform one or more operations comprising:
obtaining a set of data items associated with a set of transactions, wherein each respective data item includes an amount and one or more respective attributes, the one or more respective attributes comprising a merchant identifier and a jurisdiction identifier;
for each respective data item:
determining a funding type corresponding to the respective data item based at least in part on the one or more respective attributes; and
augmenting the respective data item based on the determined funding type and one or more attribute estimations corresponding to the one or more respective attributes;
aggregating the set of data items into respective groups based at least in part on the funding type, the merchant identifier, and the jurisdiction identifier, and
transmitting at least one of the respective groups to a service for determining whether a respective bank account includes a threshold amount of funds based on the amounts of data items in the at least one of the respective groups.
